(19) United States
(12) Patent Application Publication
(10) Pub. No.: US 2026/0366790 A1
(43) Pub. Date: Nov. 19, 2026

(54) AIR CONDITIONER DEFROSTING METHOD, CONTROLLER AND AIR CONDITIONER

(71) Applicants: SHENZHEN MEGMEET ELECTRICAL CO., LTD., Shenzhen (CN); HUNAN MEGMEET ELECTRICAL TECHNOLOGY CO., LTD., Changsha (CN)

(72) Inventors: Zan MA, Shenzhen (CN); Shenfei DU, Shenzhen (CN); Yunguang LI, Shenzhen (CN); Yinghui HE, Shenzhen (CN); Chao YANG, Shenzhen (CN); Pintong LU, Shenzhen (CN); Manzhi ZHOU, Shenzhen (CN); Jie CHEN, Shenzhen (CN)

(73) Assignees: SHENZHEN MEGMEET ELECTRICAL CO., LTD., Shenzhen (CN); HUNAN MEGMEET ELECTRICAL TECHNOLOGY CO., LTD., Changsha (CN)

(21) Appl. No.: 19/642,655

(22) Filed: Apr. 9, 2026

(30) Foreign Application Priority Data
May 13, 2025 (CN) 202510610404.0

(51) Int. Cl. F25B 49/02; F25B 47/02

(52) U.S. Cl. CPC F25B 49/022; F25B 47/025; F25B 2600/0253; F25B 2700/2103

(57) ABSTRACT

An air conditioner defrosting method, a controller, and an air conditioner, are provided. The method includes: operating a compressor in a cooling cycle at an initial frequency for a set duration. An outer coil temperature of an outdoor heat exchanger is acquired to determine whether a set target temperature is reached. In response to that the set target temperature is reached, completing defrosting; and in response to that the set target temperature is not reached, adjusting an operating frequency and the set duration to obtain a correction frequency and a correction duration. The method further includes controlling the compressor to operate at the correction frequency for the correction duration and iteratively executing the acquiring the outer coil temperature of the outdoor heat exchanger and determining whether the outer coil temperature reaches the set target temperature.

### CROSS-REFERENCE TO RELATED APPLICATION

The present application claims the benefit of priority to Chinese Patent Application No. 202510610404.0, filed on May 13, 2025, which is hereby incorporated by reference in its entirety.

### TECHNICAL FIELD

The application pertains to the field of air conditioner defrosting, and in particularly to an air conditioner defrosting method, a controller and an air conditioner.

### TECHNICAL BACKGROUND

When an air conditioner operates in a heating mode or at a low ambient temperature for a long period, its outdoor heat exchanger is prone to frosting. Severe frosting will adversely affect the heating effect. Therefore, it is necessary to periodically defrost the outdoor heat exchanger of the air conditioner. A related art provides an air conditioner defrosting method. However, in the related art, on the one hand, the outdoor heat exchanger is not sufficiently and effectively defrosted; on the other hand, the defrosting noise generated by the air conditioner is relatively high.

### SUMMARY

This disclosure provides an air conditioner defrosting method, a controller and an air conditioner.

This disclosure provides an air conditioner defrosting method. The defrosting method includes: controlling a refrigerant cycle of an air conditioner in a cooling cycle to make a compressor operate at an initial frequency for a set duration; acquiring an outer coil temperature of an outdoor heat exchanger and determining whether the outer coil temperature reaches a set target temperature; on the condition that the outer coil temperature reaches the set target temperature, completing defrosting; on the condition that the outer coil temperature does not reach the set target temperature, increasing an operating frequency of the compressor based on the outer coil temperature and correcting the set duration to obtain a correction frequency and a correction duration; controlling the compressor to operate at the correction frequency for the correction duration and executing the step of acquiring the outer coil temperature of the outdoor heat exchanger and determining whether the outer coil temperature reaches the set target temperature.

In an embodiment, the step of increasing the operating frequency of the compressor based on the outer coil temperature specifically includes: calculating a temperature difference between the set target temperature and the outer coil temperature; calculating a frequency compensation value based on the temperature difference; wherein the frequency compensation value is positively correlated with the temperature difference; compensating the operating frequency of the compressor based on the frequency compensation value.

In an embodiment, the step of calculating the frequency compensation value based on the temperature difference specifically includes: determining whether the outer coil temperature is acquired for the first time; on the condition that the outer coil temperature is acquired for the first time, a calculation formula for the frequency compensation value is: Fb=(Pt−Ps)*A; wherein Fb is the frequency compensation value; Pt is the set target temperature; Ps is the outer coil temperature of the heat exchanger; A is a temperature difference correction coefficient; on the condition that the outer coil temperature is not acquired for the first time, a calculation formula for the frequency compensation value is: Fb=(Pt−Ps)*A+{[(Pt−PsN+1)−(Pt−PsN)]*(1−A)}; wherein PsN+1 is the outer coil temperature of the heat exchanger at time N+1; PsN is the outer coil temperature of the heat exchanger at time N; 1−A is a correction coefficient of a temperature difference change rate.

In an embodiment, the step of compensating the operating frequency of the compressor based on the frequency compensation value specifically includes: determining whether the frequency compensation value is greater than a compensation threshold; on the condition that the frequency compensation value is not greater than the compensation threshold, compensating the operating frequency based on the frequency compensation value; on the condition that the frequency compensation value is greater than the compensation threshold, compensating the operating frequency based on the compensation threshold.

In an embodiment, the step of correcting the set duration specifically includes: correcting the set duration based on the frequency compensation value; wherein the correction duration is negatively correlated with the absolute value of the frequency compensation value.

In an embodiment, the step of controlling the compressor to operate at the correction frequency for the correction duration and executing the step of acquiring the outer coil temperature of the outdoor heat exchanger and determining whether the outer coil temperature reaches the set target temperature specifically includes: determining whether the correction frequency is greater than a defrosting threshold frequency; on the condition that the correction frequency is not greater than the defrosting threshold frequency, controlling the compressor to operate at the correction frequency for the correction duration; on the condition that the correction frequency is greater than the defrosting threshold frequency, controlling the compressor to operate at the defrosting threshold frequency for the correction duration.

In an embodiment, the step of on the condition that the outer coil temperature reaches the set target temperature, completing defrosting, specifically includes: on the condition that the outer coil temperature reaches the set target temperature, continuously detecting the outer coil temperature; completing defrosting in response to that the outer coil temperature reaches the set target temperature and maintains for a target duration.

In an embodiment, the defrosting method further includes: completing defrosting in response to that a defrosting duration reaches a preset duration.

Another aspect of this disclosure is to provide a controller. The controller includes a control module, an acquisition module and a determining module. The controller is configured to control the air conditioner to defrost by the above defrosting method. The control module is configured to control the refrigerant cycle of the air conditioner in the cooling cycle to make the compressor operate at the initial frequency for the set duration; the acquisition module is configured to acquire the outer coil temperature of the outdoor heat exchanger; the determining module is configured to determine whether the outer coil temperature reaches the set target temperature; on the condition that the outer coil temperature reaches the set target temperature, the control module controls to complete defrosting; on the condition that the outer coil temperature does not reach the set target temperature, the control module increases the operating frequency of the compressor based on the outer coil temperature and corrects the set duration to obtain the correction frequency and the correction duration; the control module controls the compressor to operate at the correction frequency for the correction duration and execute the step of acquiring the outer coil temperature of the outdoor heat exchanger and determining whether the outer coil temperature reaches the set target temperature.

Another aspect of this disclosure is to provide an air conditioner. The air conditioner controls defrosting by the above defrosting method.

### BRIEF DESCRIPTION OF DRAWINGS

To provide an explanation of the technical schemes in the embodiments of this disclosure, a brief introduction will be given to the accompanying drawings required in the description of the embodiments. Obviously, the accompanying drawings in the following description are only some embodiments of the disclosure. The persons skilled in the art may obtain other drawings based on these accompanying drawings without putting in creative labor.

FIG. 1 illustrates a flow diagram of refrigerant in the cooling cycle of the air conditioner according to some embodiments.

FIG. 2 illustrates a flow diagram of refrigerant in the heating cycle of the air conditioner according to some embodiments.

FIG. 3 illustrates a schematic flow diagram of an embodiment of the air conditioner defrosting method according to some embodiments.

FIG. 4 illustrates a schematic flow diagram of an embodiment of the step of increasing the operating frequency of the compressor based on the outer coil temperature in FIG. 3.

FIG. 5 illustrates a timing diagram of the air conditioner defrosting method according to some embodiments.

FIG. 6 illustrates a schematic block diagram of an embodiment of the controller according to some embodiments.

11—four-way valve; 12—compressor; 13—outdoor heat exchanger; 14—indoor heat exchanger; 15—throttle valve; 100—controller; 200—control module; 300—acquisition module; 400—determining module.

### DETAILED DESCRIPTION

The technical schemes in the embodiments in this disclosure will be described below with reference to the accompanying drawings in the embodiments in this disclosure. It is apparent that the described embodiments are merely illustrative of this disclosure and are not intended to be exhaustive. All other embodiments obtained by persons skilled in the art without putting in creative efforts based on the embodiments in this disclosure shall fall within the protection scope of this disclosure.

The terms in the embodiments in this disclosure are for describing specific embodiments only and are not intended to limit this disclosure. The singular forms “a/an,” “the” and “this” mentioned in the embodiments and the claims in this disclosure are also intended to include the plural forms, unless the context clearly indicates otherwise. The term “a plurality of” generally includes the case of two or more, but does not exclude the case of one or more.

It is to be understood that the term “and/or” in this disclosure merely describes an associative relationship between associated objects and indicates that three relationships may exist. For example, A and/or B may indicate three cases: A alone, both A and B, and B alone. In addition, the character “/” herein generally indicates that the associated objects are in an “or” relationship.

It is to be understood that the terms “include,” “comprise” or any other variants are intended to covering non-exclusive inclusion so as to enable that a process, a method, an article or a device that includes a series of elements includes not only those elements but also other elements not explicitly listed, or elements that are inherent to the process, the method, the article, or the device. Unless otherwise limited, an element defined by the phrase “including . . . ” does not preclude the presence of additional same elements in the process, the method, the article or the device that includes the element.

In the related art, when an air conditioner performs the defrosting process, a compressor operates at a defrosting frequency. During the defrosting process, an outer coil temperature of an outdoor heat exchanger is detected by a temperature sensor. Defrosting is completed when the outer coil temperature reaches a set value. However, in the related art, when the compressor operates at the defrosting frequency, the temperature of refrigerant flowing through the outdoor heat exchanger increases sharply. Thereby, the temperature sensor heats up too quickly, and the air conditioner may erroneously exit the defrosting mode, resulting in insufficient defrosting, unsatisfactory defrosting effects and high defrosting noise.

To overcome the aforementioned drawbacks, this disclosure provides an air conditioner defrosting method, a controller and an air conditioner to reduce the occurrence of erroneous exit of the defrosting mode, the insufficient defrosting, the unsatisfactory defrosting effect and the defrosting noise.

The beneficial effects of this disclosure are as follows: this disclosure provides an air conditioner defrosting method, a controller and an air conditioner. By the defrosting method, at the beginning of defrosting, the compressor is controlled to operate at the initial frequency which is relatively low. Thus, at the beginning of defrosting, when the outer coil temperature of the outdoor heat exchanger is relatively low, the temperature and pressure of the refrigerant will not increase sharply, and the refrigerant flow rate remains small, so the temperature of the temperature sensor will also not increase sharply. As a result, the temperature sensor can accurately show the defrosting state of the outdoor heat exchanger. The defrosting method reduces the insufficient defrosting caused by the air conditioner erroneous exiting the defrosting mode due to a sharp temperature increase detected by the temperature sensor. In addition, the defrosting method shortens the operation duration of the compressor at high frequency, thereby reducing the defrosting noise of the air conditioner.

The following is a detailed description of an air conditioner defrosting method, a controller and an air conditioner in this disclosure with reference to the accompanying drawings and embodiments.

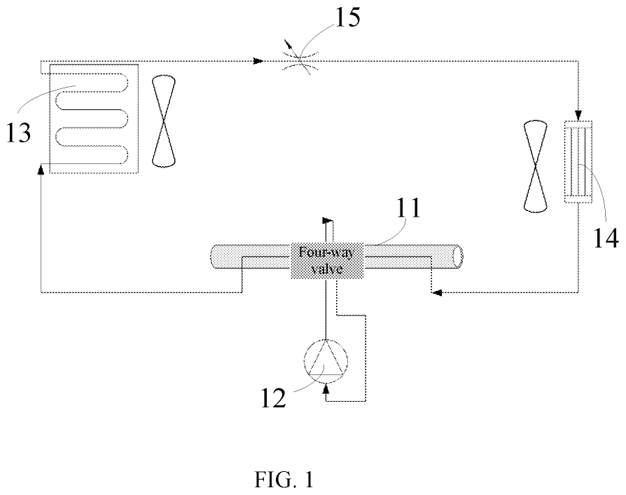

This disclosure provides an air conditioner defrosting method for defrosting an outdoor heat exchanger of an air conditioner. In an embodiment, referring to FIG. 1, FIG. 1 illustrates a structural schematic diagram of an embodiment of the air conditioner according to some embodiments. In a specific embodiment, the air conditioner includes a four-way valve 11, a compressor 12, a throttle valve 15, an outdoor heat exchanger 13 and an indoor heat exchanger 14.

In some embodiments, the compressor 12 compresses the low-temperature and low-pressure gaseous refrigerant and converts it to the high-temperature and high-pressure gaseous refrigerant. The four-way valve 11 is configured to switch the state and change the flow direction of refrigerant. It serves to switch between the cooling mode and the heating mode of the air conditioner. When the refrigerant cycle is in the cooling cycle, the four-way valve 11 switches the flow direction of refrigerant to the outdoor heat exchanger 13. When the refrigerant cycle is in the heating cycle, the four-way valve 11 changes the internal communication state, making the refrigerant flow through the indoor heat exchanger 14 to the outdoor heat exchanger 13.

In an embodiment, referring to FIG. 1, FIG. 1 illustrates a flow diagram of refrigerant in the cooling cycle of the air conditioner according to some embodiments.

In the cooling mode, the refrigerant flows in the following sequence: the compressor 12 (discharge)→the four-way valve 11 (towards the outdoor heat exchanger)→the outdoor heat exchanger 13→the throttle valve 15→the indoor heat exchanger 14→the four-way valve 11 (towards the indoor heat exchanger)→the compressor 12 (suction). In some embodiments, the compressor 12 converts the low-temperature and low-pressure gaseous refrigerant into high-temperature and high-pressure gaseous refrigerant. The process of the high-temperature and high-pressure gaseous refrigerant flowing from the compressor 12 to the four-way valve 11 is a discharge process of the compressor 12. In the cooling mode, the high-temperature and high-pressure gaseous refrigerant first enters the outdoor heat exchanger 13, is cooled in the outdoor heat exchanger 13 by exchanging heat with the outside ambient air, and becomes medium-temperature and high-pressure liquid refrigerant by releasing heating. The medium-temperature and high-pressure liquid refrigerant from the outdoor heat exchanger 13 flows through the throttle valve 15, partially evaporates and absorbs heat due to the sudden decrease in pressure, and becomes a low-temperature and low-pressure gas-liquid mixture. The gas-liquid mixture enters the indoor heat exchanger 14, exchanges heat with indoor air, absorbs the indoor heat and becomes low-temperature and low-pressure gaseous refrigerant by evaporation, thereby reducing the indoor temperature. Therefore, in the cooling mode, the refrigerant flows in a high-temperature and high-pressure state from the compressor 12 to the four-way valve 11, from the four-way valve 11 to the outdoor heat exchanger 13, and from the outdoor heat exchanger 13 to the throttle valve 15. The refrigerant flows in a low-temperature and low-pressure state from the throttle valve 15 to the indoor heat exchanger 14, from the indoor heat exchanger 14 to the four-way valve 11, and from the four-way valve 11 to the compressor 12. The process of the low-temperature and low-pressure refrigerant flowing from the four-way valve 11 to the compressor 12 is the suction process of the compressor 12. In the cooling mode, the refrigerant in the outdoor heat exchanger 13 flows in a high-temperature and high-pressure state, thus realizing defrosting of the outdoor heat exchanger 13.

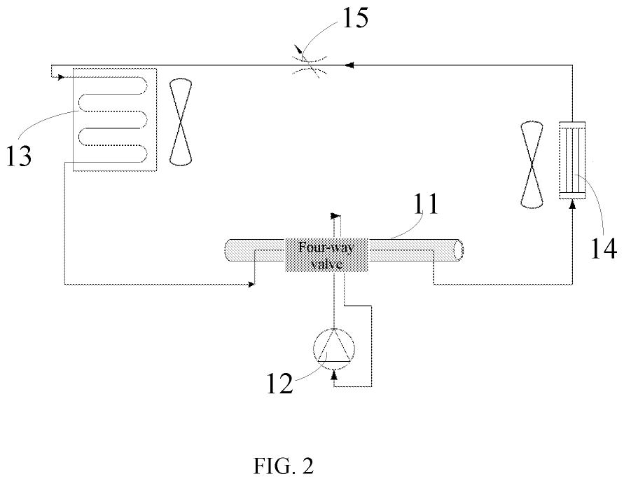

In an embodiment, referring to FIG. 2, FIG. 2 illustrates a flow diagram of refrigerant in the heating cycle of the air conditioner according to some embodiments.

In the heating mode, the four-way valve 11 switches the flow direction and makes the refrigerant flow in the following sequence: the compressor 12 (discharge)→the four-way valve 11 (the indoor heat exchanger passage)→the indoor heat exchanger 14→the throttle valve 15→the outdoor heat exchanger 13→the four-way valve 11 (the outdoor heat exchanger passage)→the compressor 12 (suction). In the heating mode, the refrigerant flows in a high-temperature and high-pressure state from the compressor 12 to the four-way valve 11, from the four-way valve 11 to the indoor heat exchanger 14 and from the indoor heat exchanger 14 to the throttle valve 15; the refrigerant flows in a low-temperature and low-pressure state from the throttle valve 15 to the outdoor heat exchanger 13, from the outdoor heat exchanger 13 to the four-way valve 11, and from the four-way valve 11 to the compressor 12. In the heating mode, the high-temperature and high-pressure refrigerant in the indoor heat exchanger 14 releases heat into the indoor air, thereby achieving the heating effect.

As described above, when the refrigerant cycle of the air conditioner is in the cooling cycle, the refrigerant in the outdoor heat exchanger 13 flows in a high-temperature and high-pressure state, thereby achieving the defrosting effect.

This disclosure provides an air conditioner defrosting method to sufficiently defrost the outdoor heat exchanger and improve the defrosting effect.

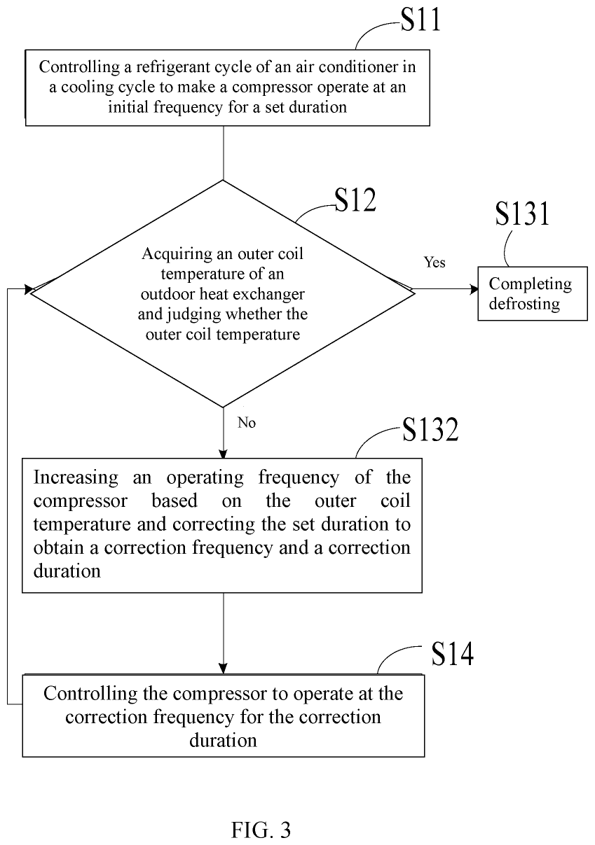

In an embodiment, referring to FIG. 3, FIG. 3 illustrates a schematic flow diagram of an embodiment of the air conditioner defrosting method according to some embodiments. In a specific embodiment, the defrosting method includes:
S11: Controlling a refrigerant cycle of an air conditioner in a cooling cycle to make a compressor operate at an initial frequency for a set duration.

The cooling cycle is as described above. In the related art, during defrosting of the air conditioner, the compressor operates directly at a defrosting threshold frequency. The defrosting threshold frequency is relatively high. At the frequency, both the temperature and pressure of the refrigerant sharply increase, the flow rate of the refrigerant is high and the difference between the refrigerant temperature and the outdoor heat exchanger temperature is significant. Therefore, the temperature sensor heats up too quickly, the temperature detected by the temperature sensor may increase to a relatively high level, but the frost on the outdoor heat exchanger remains unmelted, resulting in a failure to accurately show the defrosting state of the outdoor heat exchanger. In the step, the compressor operates at the initial frequency which is relatively low. In some embodiments, the initial frequency is specifically 0.4, 0.45, 0.5, 0.6 times the defrosting threshold frequency, etc. When the compressor operates at the initial frequency, a proper amount of refrigerant is discharged from the compressor and enters the outdoor heat exchanger. The temperature, pressure and flow rate of the refrigerant will not be excessively high, so there will be no sharp increase in the temperature of the temperature sensor. When the compressor operates at the initial frequency, the outdoor heat exchanger heats up slowly, resulting in slow defrosting. The temperature detected by the temperature sensor can accurately show the defrosting state of the outdoor heat exchanger in real time. In some embodiments, the set duration is a fixed value, which is specifically 60s, 50s, 65s, 70s or other reasonable values. In addition, on the condition that the compressor starts operation at the initial frequency, the defrosting noise can be reduced.

In some embodiments, the four-way valve is switched to make the refrigerant cycle of the air conditioner in the cooling cycle.

In some embodiments, the step further includes shutting down the outdoor fan to stop blowing the outdoor heat exchanger when defrosting so as to improve defrosting efficiency.
S12: Acquiring an outer coil temperature of an outdoor heat exchanger and determining whether the outer coil temperature reaches a set target temperature.

In the embodiment, the outer coil temperature of the outdoor heat exchanger is detected by the temperature sensor. In some other embodiments, the outer coil temperature may also be detected by an infrared sensor or other types of temperature detection devices.

In some embodiments, the temperatures at different positions on the outdoor heat exchanger may be different. For example, the temperature at a position on the outdoor heat exchanger close to the compressor tends to be higher than that at a position far from the compressor. In some embodiments, the temperature sensor is arranged on the side of the outdoor heat exchanger far from the compressor. When the outer coil temperature of the outdoor heat exchanger far from the compressor can reach the set target temperature, the temperatures at all positions on the outdoor heat exchanger can reach the set target temperature. The position arrangement of the temperature sensor can realize more sufficient defrosting and improve the defrosting effect. In some other embodiments, the temperature sensor may also be arranged at other positions on the outdoor heat exchanger. In addition, the number of temperature sensors may also be plural. The average value of a plurality of temperature values can show the overall defrosting state of the outdoor heat exchanger.

In some embodiments, the set target temperature is a few degrees above zero degrees, specifically, may be 8 °C, 9 °C, 10 °C and other reasonable temperatures. Understandably, the frosting temperature is approximately zero degrees. On the condition that the set target temperature is set to a few degrees above zero degrees, when the outer coil temperature reaches the target temperature, the outdoor heat exchanger can be defrosted more sufficiently, and the defrosting effect can be improved.

In some embodiments, in the step, on the condition that the outer coil temperature reaches the set target temperature, execute S131; on the condition that the outer coil temperature does not reach the set target temperature, execute S132.
S131: Completing defrosting.

In some embodiments, when the acquired outer coil temperature reaches the set target temperature, continuously detect the outer coil temperature; defrosting is completed in response to that the outer coil temperature reaches the set target temperature and maintains for a target duration.

In some embodiments, the step further includes starting up the outdoor fan to blow off the water droplets on the outdoor heat exchanger.

On the condition that the outer coil temperature is lower than the set target temperature again, execute S132.
S132: Increasing an operating frequency of the compressor based on the outer coil temperature and correcting the set duration to acquire a correction frequency and a correction duration.

After the compressor operates at the frequency prior to increasing frequency for a period of time, the outdoor heat exchanger warms up to some extent, and partial frost on the outdoor heat exchanger is melted. On the condition that the compressor continuously operates at the frequency prior to increasing frequency, there is a tendency for too small of the temperature difference between the refrigerant and the heat exchanger, resulting in excessively slow defrosting. Therefore, after the compressor operates at the frequency prior to increasing frequency for a period of time, the operating frequency of the compressor shall be increased to speed up defrosting. On the other hand, because the outdoor heat exchanger has already been preheated and warmed up by the compressor which operates at the initial frequency, in the step, the operating frequency is increased, thereby avoiding insufficient defrosting caused by too high difference between the refrigerant temperature and the outdoor heat exchanger, too fast heating of the temperature sensor, and erroneous exit of the defrosting mode.

In some embodiments, the operating frequency is increased based on the outer coil temperature. For example, the higher the outer coil temperature, the faster the outer coil defrosting, and thus the lower the compensation value of the operating frequency of the compressor; the lower the outer coil temperature, the slower the outer coil defrosting, and thus the higher the compensation value of the operating frequency of the compressor.

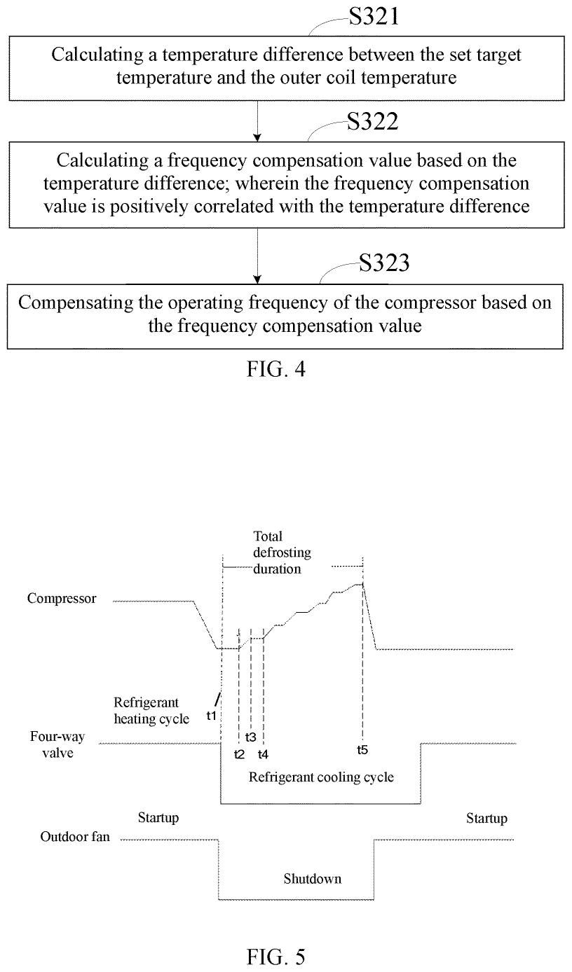

In an embodiment, referring to FIG. 4, FIG. 4 illustrates a schematic flow diagram of an embodiment of the step of increasing the operating frequency of the compressor based on the outer coil temperature in FIG. 3. In some other embodiments, the step of increasing the operating frequency of the compressor based on the outer coil temperature specifically includes:
S321: Calculating a temperature difference between the set target temperature and the outer coil temperature;

In some embodiments, the outer coil temperature is lower than the target temperature, and the different between the target temperature and the outer coil temperature is defined as the temperature difference.
S322: Calculating a frequency compensation value based on the temperature difference; in some embodiments, the frequency compensation value is positively correlated with the temperature difference.

When the temperature difference is greater, the outer coil temperature of the outdoor heat exchanger is lower and the defrosting progress is slower. Therefore, the frequency compensation value shall be higher to speed up defrosting. When the temperature difference is smaller, the outer coil temperature of the outdoor heat exchanger is higher, and the outer coil defrosting process is faster. Therefore, the frequency compensation value shall be lower.

In some embodiments, the step of calculating a frequency compensation value based on the temperature difference specifically includes: determining whether the outer coil temperature is acquired for the first time; on the condition that the outer coil temperature is acquired for the first time, a calculation formula for the frequency compensation value is: Fb=(Pt−Ps)*A; in some embodiments, Fb is the frequency compensation value; Pt is the set target temperature; Ps is the outer coil temperature of the heat exchanger; A is a temperature difference correction coefficient. In above formula, A is a constant and is greater than 0 and less than 1. The frequency compensation value is positively correlated with the temperature difference. On the condition that the outer coil temperature is not acquired for the first time, a calculation formula for the frequency compensation value is: Fb=(Pt−Ps)*A+{[(Pt−PsN+1)−(Pt−PsN)]*(1−A)}; in some embodiments, PsN+1 is the outer coil temperature of the heat exchanger at time N+1; PsN is the outer coil temperature of the heat exchanger at time N; 1−A is a correction coefficient of a temperature difference change rate. In above formula, [(Pt−PsN+1)−(Pt−PsN)] is the temperature difference change rate which shows the change speed of the temperature difference. It can be calculated by comparing the temperature difference calculated from the currently acquired outer coil temperature with the temperature difference calculated from the previously acquired outer coil temperature.

It is easy to understand that both the operating frequency and the frequency increase value of the compressor are integers. In some embodiments, the frequency compensation value calculated by the formula is also rounded to an integer. On the condition that the frequency compensation value obtained by the formula is 4.6, the frequency compensation value is rounded to 4 Hz. On the condition that the frequency compensation value obtained by the formula is 3.4, the frequency compensation value is rounded to 3 Hz.
S323: Compensating the operating frequency of the compressor based on the frequency compensation value.

In the step, the operating frequency of the compressor increases by the frequency compensation value and the compressor operates at the correction frequency after increasing the frequency. In some embodiments, when the frequency compensation value is calculated as a negative value, the frequency compensation value is set to 0 Hz to compensate the operating frequency. That is to say, when the frequency compensation value is negative, the operating frequency of the compressor remains unchanged.

In addition, an excessively high frequency compensation value necessitates a substantial increase in the operating frequency of the compressor. Consequently, the excessive frequency increase in a short time may impair user comfort, furthermore, may result in a sharp temperature increase detected by the temperature sensor, which precludes the temperature sensor from accurately showing the outer coil temperature of the outdoor heat exchanger. To solve the above-mentioned problems, in some embodiments, the step of compensating the operating frequency of the compressor based on the frequency compensation value specifically includes: determining whether the frequency compensation value is greater than a compensation threshold; on the condition that the frequency compensation value is not greater than the compensation threshold, compensating the operating frequency based on the frequency compensation value; on the condition that the frequency compensation value is greater than the compensation threshold, compensating the operating frequency based on the compensation threshold. For example, in a specific embodiment, the compensation threshold is set to 8 Hz. When the calculated frequency compensation value is greater than 8 Hz, such as, 9 Hz, 10 Hz or other values, the operating frequency of the compressor is increased by 8 Hz.

In some embodiments, the step of correcting the set duration specifically includes: correcting the set duration based on the frequency compensation value. In some embodiments, the correction duration is negatively correlated with the absolute value of the frequency compensation value. For example, in a specific embodiment, the set duration T is set to 60s, and the relationship between the correction duration and the frequency compensation value is shown in Table 1:

TABLE 1

| | Absolute value of frequency compensation value | | | | |
|---|---|---|---|---|---|
| | Fb ≥ 8 | 8 > Fb ≥ 6 | 6 > Fb ≥ 4 | 4 > Fb ≥ 2 | 2 > Fb |
| Correction | T*0.5 | T*0.6 | T*0.7 | T*0.8 | T |
| duration | | | | | |

As shown in the above table, on the condition that the absolute value of the obtained frequency compensation value is 7 Hz, the correction duration is T*0.6, which equals 36s. On the condition that the absolute value of the calculated frequency compensation value is 5 Hz, the correction duration is T*0.7, which equals 42s.
S14: Controlling the compressor to operate at the correction frequency for the correction duration.

The step is executed after S132. S12 is executed again after the step. For example, in a specific embodiment, the operating frequency of the compressor is set to 40 Hz, the frequency compensation value obtained in the previous step is 7 Hz and the correction duration is 36s. Therefore, the correction frequency is 47 Hz. After controlling the compressor to operate at 47 Hz for 36s, S12 is executed again.

Further, by the defrosting method in this disclosure, the compressor starts operating at the initial frequency. During defrosting, the frequency of the compressor is continuously compensated based on changes in the outer coil temperature of the outdoor heat exchanger, such that the frequency of the compressor gradually increases. In some embodiments, an air conditioner is usually set with a defrosting threshold frequency which is the maximum set operating frequency of the compressor during defrosting. Exceeding the maximum operating frequency of the compressor may adversely affect the comfort of indoor users. In some embodiments, before executing S14, the defrosting method further includes: determining whether the correction frequency is greater than a defrosting threshold frequency; on the condition that the correction frequency is not greater than the defrosting threshold frequency, controlling the compressor to operate at the correction frequency for the correction duration; on the condition that the correction frequency is greater than the defrosting threshold frequency, controlling the compressor to operate at the defrosting threshold frequency for the correction duration.

In some embodiments, the defrosting method further includes: completing defrosting in response to that a defrosting duration reaches a preset duration. Specifically, this configuration can reduce problems that the air conditioner cannot defrost normally or cannot exit the defrosting mode due to switching failures of the four-way valve or malfunctions of the temperature sensor.

Different from the related art, by the defrosting method, at the beginning of defrosting, the compressor is controlled to operate at the initial frequency which is relatively low. Thus, at the beginning of defrosting, when the outer coil temperature of the outdoor heat exchanger is relatively low, the temperature and pressure of the refrigerant will not increase sharply, and the refrigerant flow rate remains small, so the temperature of the temperature sensor will also not increase sharply. As a result, the temperature sensor can accurately show the defrosting state of the outdoor heat exchanger. The defrosting method reduces the insufficient defrosting caused by the air conditioner erroneous exiting the defrosting mode due to a sharp temperature increase detected by the temperature sensor. In addition, the defrosting method shortens the operation duration of the compressor at high frequency, thereby reducing the defrosting noise of the air conditioner.

Finally, in an embodiment, referring to FIG. 5, FIG. 5 illustrates a timing diagram of the air conditioner defrosting method according to some embodiments. During defrosting of an air conditioner, the initial frequency is 40 Hz, the set target temperature is 15 °C, the set duration T is 60s, the temperature difference correction coefficient A is 0.6, the compensation threshold is 8 Hz, and the relationship between the correction duration and the frequency compensation value is shown in Table 1. Then, during controlling defrosting of the air conditioner by the defrosting method, the refrigerant cycle is controlled in the cooling cycle. In some embodiments, the period from t1 to t2 in FIG. 5 illustrates the operation of the compressor at 40 Hz for 60s. At t1, the four-way valve switches the refrigerant to the cooling cycle, and the outdoor fan is shut down. After the compressor operates for 60s, the acquired outer coil temperature of the outdoor heat exchanger is −6 °C. Then, the frequency compensation value Fb=(Pt−Ps)*A=12.6; the frequency compensation value is 8, the correction frequency is 48 Hz, and the correction duration is 30s. The compressor is controlled to increase the frequency. The period from t2 to t3 illustrates the frequency increase of the compressor. The compressor is continuously controlled to operate at the correction frequency 48 Hz for 30s. The period from t3 to t4 illustrates the operation of the compressor at 48 Hz for 30s. The outer coil temperature is acquired again. At this time, the outer coil temperature increases to 2 °C. Then, the frequency compensation value Fb=(Pt−Ps)*A+{[(Pt−PsN+1)−(Pt−PsN)]*(1−A)}=7.8−3.2=4.6; the frequency compensation value Fb is rounded to 4, the correction frequency is 52 Hz, and the correction duration is 42s. The compressor is continuously controlled to operate at the correction frequency 52 Hz for 42s and the outer coil temperature is acquired repeatedly. At t5 in FIG. 5, defrosting is completed, and the outdoor fan is started up to blow off water droplets.

By the above defrosting method, at the beginning of defrosting, the compressor is controlled to operate at the initial frequency which is relatively low. Thus, at the beginning of defrosting, when the outer coil temperature of the outdoor heat exchanger is relatively low, the temperature and pressure of the refrigerant will not increase sharply, and the refrigerant flow rate remains small, so the temperature of the temperature sensor will also not increase sharply. As a result, the temperature sensor can accurately show the defrosting state of the outdoor heat exchanger. The defrosting method reduces the insufficient defrosting caused by the air conditioner erroneous exiting the defrosting mode due to a sharp temperature increase detected by the temperature sensor. In addition, the defrosting method shortens the operation duration of the compressor at high frequency, thereby reducing the defrosting noise of the air conditioner.

Correspondingly, this disclosure also provides an air conditioner to control defrosting by the defrosting method in the above embodiments.

In some embodiments, the air conditioner includes a compressor, an indoor heat exchanger, an outdoor heat exchanger, a four-way valve and a throttle valve; the compressor includes a discharge port and a suction port; the four-way valve includes a first passage and a second passage; the four-way valve is configured to switch its communication state so that when the refrigerant cycle is in the heating cycle, a heating loop is formed by connecting the discharge port of the compressor, the first passage of the four-way valve (the indoor heat exchanger passage), the indoor heat exchanger, the throttle valve, the outdoor heat exchanger, the second passage of the four-way valve (the outdoor heat exchanger passage) and the suction port of the compressor in sequence; when the refrigerant cycle is in the cooling cycle, a cooling loop is formed by connecting the discharge port of the compressor, the second passage of the four-way valve, the outdoor heat exchanger, the throttle valve, the indoor heat exchanger, the first passage of the four-way valve and the suction port of the compressor in sequence.

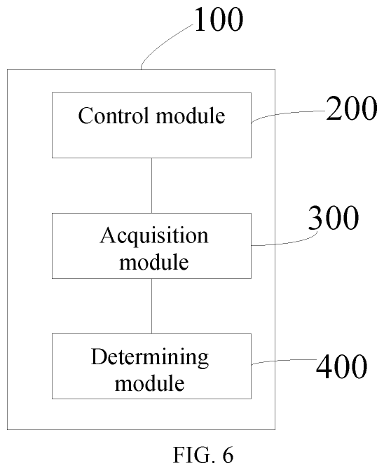

Correspondingly, this disclosure further provides a controller. In some embodiments, referring to FIG. 6, FIG. 6 illustrates a schematic block diagram of an embodiment of the controller according to some embodiments. The controller 100 includes a control module 200, an acquisition module 300 and a determining module 400. The control module 200 is configured to control the refrigerant cycle of the air conditioner in the cooling cycle to make the compressor operate at the initial frequency for the set duration; the acquisition module 300 is configured to acquire the outer coil temperature of the outdoor heat exchanger; the determining module 400 is configured to determine whether the outer coil temperature reaches the set target temperature; on the condition that the outer coil temperature reaches the set target temperature, the control module 200 controls to complete defrosting; on the condition that the outer coil temperature does not reach the set target temperature, the control module 200 increases the operating frequency of the compressor based on the outer coil temperature and corrects the set duration to obtain the correction frequency and the correction duration; the control module 200 controls the compressor to operate at the correction frequency for the correction duration and execute the step of acquiring the outer coil temperature of the outdoor heat exchanger and determining whether the outer coil temperature reaches the set target temperature.

In some embodiments, the step of the control module 200 increasing the operating frequency of the compressor based on the outer coil temperature specifically includes: calculating a temperature difference between the set target temperature and the outer coil temperature; calculating a frequency compensation value based on the temperature difference; in some embodiments, the frequency compensation value is positively correlated with the temperature difference; compensating the operating frequency of the compressor based on the frequency compensation value.

In some embodiments, the step of the control module 200 calculating a frequency compensation value based on the temperature difference specifically includes: determining whether the outer coil temperature is acquired for the first time; on the condition that the outer coil temperature is acquired for the first time, a calculation formula for the frequency compensation value is: Fb=(Pt−Ps)*A; in some embodiments, Fb is the frequency compensation value; Pt is the set target temperature; Ps is the outer coil temperature of the heat exchanger; A is a temperature difference correction coefficient; on the condition that the outer coil temperature is not acquired for the first time, a calculation formula for the frequency compensation value is: Fb=(Pt−Ps)*A+{[(Pt−PsN+1)−(Pt−PsN)]*(1−A)}; in some embodiments, PsN+1 is the outer coil temperature of the heat exchanger at time N+1; PsN is the outer coil temperature of the heat exchanger at time N; 1−A is a correction coefficient of a temperature difference change rate.

In some embodiments, the step of the control module 200 compensating the operating frequency of the compressor based on the frequency compensation value specifically includes: determining whether the frequency compensation value is greater than a compensation threshold; on the condition that the frequency compensation value is not greater than the compensation threshold, compensating the operating frequency based on the frequency compensation value; on the condition that the frequency compensation value is greater than the compensation threshold, compensating the operating frequency based on the compensation threshold.

In some embodiments, the step of the control module 200 correcting the set duration specifically includes: correcting the set duration based on the frequency compensation value; wherein the correction duration is negatively correlated with the frequency compensation value.

In some embodiments, the step of the control module 200 controlling the compressor to operate at the correction frequency for the correction duration and executing the step of acquiring the outer coil temperature of the outdoor heat exchanger and determining whether the outer coil temperature reaches the set target temperature specifically includes: determining whether the correction frequency is greater than a defrosting threshold frequency; on the condition that the correction frequency is not greater than the defrosting threshold frequency, controlling the compressor to operate at the correction frequency for the correction duration; on the condition that the correction frequency is greater than the defrosting threshold frequency, controlling the compressor to operate at the defrosting threshold frequency for the correction duration.

In some embodiments, the step of on the condition that the outer coil temperature reaches the set target temperature, completing defrosting, specifically includes: on the condition that the outer coil temperature reaches the set target temperature, continuously detecting the outer coil temperature; completing defrosting in response to that the outer coil temperature reaches the set target temperature and maintains for a target duration.

In some embodiments, the defrosting method further includes: completing defrosting in response to that a defrosting duration reaches a preset duration.

The foregoing description is merely the embodiments of the present disclosure and constitutes no limitation to the scope of the patent. Any transformation of equivalent structures or equivalent processes made by reference of the specification and accompanying drawings in this disclosure of the patent, or any direct or indirect disclosure in other related technical fields are included in the protection scope of the patent of this disclosure.

What is claimed is:

1. An air conditioner defrosting method, comprising:
controlling a refrigerant cycle of an air conditioner to operate in a cooling cycle, such that a compressor operates at an initial frequency for a set duration;
acquiring an outer coil temperature of an outdoor heat exchanger and determining whether the outer coil temperature reaches a set target temperature;
in response to the outer coil temperature reaching the set target temperature, completing defrosting;
in response to the outer coil temperature not reaching the set target temperature, increasing an operating frequency of the compressor based on the outer coil temperature to obtain a correction frequency and correcting the set duration to obtain a correction duration; and
controlling the compressor to operate at the correction frequency for the correction duration and iteratively executing the acquiring the outer coil temperature of the outdoor heat exchanger and determining whether the outer coil temperature reaches the set target temperature.

2. The air conditioner defrosting method according to claim 1, wherein the increasing the operating frequency of the compressor based on the outer coil temperature further comprises:
calculating a temperature difference between the set target temperature and the outer coil temperature;
calculating a frequency compensation value based on the temperature difference, wherein the frequency compensation value is positively correlated with the temperature difference; and
compensating the operating frequency of the compressor based on the frequency compensation value.

3. The air conditioner defrosting method according to claim 2, wherein the calculating the frequency compensation value based on the temperature difference further comprises:
determining whether the outer coil temperature is acquired in a first iteration;
in response to the outer coil temperature being acquired in the first iteration, calculating the frequency compensation value according to a first formula, wherein the first formula is:
Fb=(Pt−Ps)*A,
wherein Fb is the frequency compensation value, Pt is the set target temperature, Ps is the outer coil temperature of the heat exchanger, and A is a temperature difference correction coefficient; and
in response to the outer coil temperature being acquired in an iteration other than the first iteration, calculating the frequency compensation value according to a second formula, wherein the second formula is:
Fb=(Pt−Ps)*A+{[(Pt−PsN+1)−(Pt−PsN)]*(1−A)},
wherein PsN+1 is the outer coil temperature of the heat exchanger at time N+1, PsN is the outer coil temperature of the heat exchanger at time N, and 1−A is a correction coefficient of a temperature difference change rate.

4. The air conditioner defrosting method according to claim 2, wherein the compensating the operating frequency of the compressor based on the frequency compensation value further comprises:
determining whether the frequency compensation value is greater than a compensation threshold;
in response to the frequency compensation value not being greater than the compensation threshold, compensating the operating frequency based on the frequency compensation value; and
in response to the frequency compensation value being greater than the compensation threshold, compensating the operating frequency based on the compensation threshold.

5. The air conditioner defrosting method according to claim 2, wherein the correcting the set duration further comprises:
correcting the set duration based on the frequency compensation value, wherein the correction duration is negatively correlated with an absolute value of the frequency compensation value.

6. The air conditioner defrosting method according to claim 1, wherein the controlling the compressor to operate at the correction frequency for the correction duration and iteratively executing the acquiring the outer coil temperature of the outdoor heat exchanger and determining whether the outer coil temperature reaches the set target temperature further comprises:
determining whether the correction frequency is greater than a defrosting threshold frequency;
in response to the correction frequency not being greater than the defrosting threshold frequency, controlling the compressor to operate at the correction frequency for the correction duration; and
in response to the correction frequency being greater than the defrosting threshold frequency, controlling the compressor to operate at the defrosting threshold frequency for the correction duration.

7. The air conditioner defrosting method according to claim 1, wherein the completing defrosting in response to the outer coil temperature reaching the set target temperature, further comprises:
in response to the outer coil temperature reaching the set target temperature, continuously detecting the outer coil temperature; and
completing defrosting in response to the outer coil temperature reaching the set target temperature and maintaining the set target temperature for a target duration.

8. The air conditioner defrosting method according to claim 1, further comprising:
completing defrosting in response to a defrosting duration reaching a preset duration.

9. A controller, comprising:
a memory storing computer-readable instructions; and
a processor coupled to the memory and configured to execute the computer-readable instructions, wherein the computer-readable instructions, when executed by the processor, cause the processor to perform an air conditioner defrosting method comprising:
controlling a refrigerant cycle of an air conditioner to operate in a cooling cycle, such that a compressor operates at an initial frequency for a set duration;
acquiring an outer coil temperature of an outdoor heat exchanger and determining whether the outer coil temperature reaches a set target temperature;
in response to the outer coil temperature reaching the set target temperature, completing defrosting;
in response to the outer coil temperature not reaching the set target temperature, increasing an operating frequency of the compressor based on the outer coil temperature to obtain a correction frequency and correcting the set duration to obtain a correction duration; and
controlling the compressor to operate at the correction frequency for the correction duration and iteratively executing the acquiring the outer coil temperature of the outdoor heat exchanger and determining whether the outer coil temperature reaches the set target temperature.

10. An air conditioner, comprising a controller, wherein the controller comprises:
a memory storing computer-readable instructions; and
a processor coupled to the memory and configured to execute the computer-readable instructions, wherein the computer-readable instructions, when executed by the processor, cause the processor to perform an air conditioner defrosting method comprising:
controlling a refrigerant cycle of the air conditioner to operate in a cooling cycle, such that a compressor operates at an initial frequency for a set duration;
acquiring an outer coil temperature of an outdoor heat exchanger and determining whether the outer coil temperature reaches a set target temperature;
in response to the outer coil temperature reaching the set target temperature, completing defrosting;
in response to the outer coil temperature not reaching the set target temperature, increasing an operating frequency of the compressor based on the outer coil temperature to obtain a correction frequency and correcting the set duration to obtain a correction duration; and
controlling the compressor to operate at the correction frequency for the correction duration and iteratively executing the acquiring the outer coil temperature of the outdoor heat exchanger and determining whether the outer coil temperature reaches the set target temperature.
